(19) United States
(12) Patent Application Publication
(10) Pub. No.: US 2018/0230963 A1
(43) Pub. Date: Aug. 16, 2018

(54) Device Which Applies Work To Outside With Environmental Thermal Energy

(71) Applicant: Yigang Yu, Dongguan (CN)

(72) Inventor: Yigang Yu, Dongguan (CN)

(21) Appl. No.: 15/675,038

(22) Filed: Aug. 11, 2017

(30) Foreign Application Priority Data
Feb. 14, 2017 (CN) 201710077773.3

(51) Int. Cl. F03C 1/007; F03C 1/00; F01B 17/04

(52) U.S. Cl. CPC F03C 1/0073; F01B 17/04; F03C 1/002

(57) ABSTRACT

The present invention relates to a device which applies work to the outside with environmental thermal energy, including a positive feedback heat pump system and a reciprocating multi-stage heat exchange working system. A high temperature heat source and a low temperature heat source are produced using a positive feedback heat pump, and at the same time the reciprocating multistage heat exchange working device applies work with heat energy and cold energy. As we can get several times of heat energy and cold energy when a certain amount of electric energy is consumed by a heat pump, and the thermal efficiency of the reciprocating multistage heat exchange working system is 100% theoretically, so we can get several times of electric energy. That is to say, its output is much bigger than its input, and the device can run without electric energy input, and provide electric energy to the outside.

### FIELD OF THE INVENTION

The present invention relates to the power machinery technical field, and more specifically to a device for applying work to the outside by using environmental thermal energy.

### BACKGROUND OF THE INVENTION

Because of constant economic development, each country has a huge requirement for energy that increases gradually. While the energy, such as oil, coal and natural gas, will be exhausted eventually, new energy has to be found for the continuous development of the economy. However, all technologies for obtaining energy have their own shortcomings, such as high cost, danger, exhaust, pollution and damage to the environment. Even power generation with clean energy, such as hydropower, wind power and terrestrial heat, is limited by the geographical environment, and a multitude of devices are required. The cost is extremely high, and it cannot resolve the increasingly urgent energy problem completely.

There exists an abundance of energy in our living environment. Only wind power and solar energy are used with today's technologies, while heat energy in the environment is seldom employed. Heat energy in the environment has the largest content of all energy, but it is not exploited. The patent can effectively convert heat energy in the environment into mechanical energy, make energy ubiquitous and as free as air.

### DESCRIPTION OF THE INVENTION

The purpose of the present invention is to provide a device which applies work to the outside with environmental thermal energy. The device can convert thermal energy in the environment into mechanical energy and output. It is environmentally friendly and convenient to use.

To achieve the above purpose, the present invention provides a device which applies work to the outside with environmental thermal energy, comprising a positive feedback heat pump system and a reciprocating multistage heat exchange working system. The positive feedback heat pump creates a high temperature heat source and a low temperature heat source. At the same time, the reciprocating multistage heat exchange working device applies work with heat energy and cold energy. First, the fluid working medium is moved in the forward direction and passes multiple containers with energy storage media, so that the fluid working medium gradually cools down or heats up to the required temperature. At the same time, energy storage mediums with different qualities are obtained. Subsequently, fluid working mediums are moved in a reverse direction in turn and pass through multiple containers with energy storage mediums, so that the link gradually heats or cools to the required temperature to use heat energy or cold energy stored in the storage medium once again, and to make full use of heat energy or cold energy. As we can get several times of heat energy and cold energy when a certain amount of electric energy is consumed by a heat pump(even a normal heat pump), and the thermal efficiency of reciprocating multistage heat exchange working system is 100% theoretically, so we can get several times of electric energy, that is to say, its output is much bigger than its input, the device can run without electric energy input, and provide electric energy to outside.

The technical proposal has two main characteristics.

1. A Reciprocating Multistage Heat Exchange Working System:

The present invention uses the mode of reciprocating multistage heat exchange. First, fluid moving in the positive direction passes through multiple containers with energy storage mediums. The energy storage medium is generally water, solution or oil. A link gradually cools down or heats up to the required temperature. At the same time, cold and hot mediums with different qualities are obtained. Subsequently, fluids are moved in a reverse direction in turn and pass multiple containers with energy storage mediums, so that the link gradually heats or cools to the required temperature to use heat energy or cold energy stored in the storage medium once again, and to make full use of heat energy or cold energy.

The medium can be steam, gas or liquid. The reciprocating multistage heat power device is a new kind of heat engine, which is mainly characterized by no heat exhausted to the environment. By using liquid, it is easier to achieve the effect of small volume and large power. An ordinary hydraulic system is not a heat engine. It does not work by using the expansion of liquid when heated. Its working medium is generally liquid with a low thermal expansion coefficient. An ordinary hydraulic system will have a heating problem during usage, because liquid has a high specific gravity and a high viscous resistance. A large amount of energy converts into the kinetic energy of liquid, and then into heat energy, so that the energy efficiency of the hydraulic system is reduced, and it may cause overheating. Here, when liquid is used, it is a new kind of heat engine which works by using the expansion of liquid with a high thermal expansion coefficient when heated. Because of the presence of multistage heat exchange, even some mechanical energy converted into heat energy can be reused, and again converted into mechanical energy. Additionally, because heat energy will be absorbed by the energy storage medium there will be no problem of overheating. The new heat engine is different from the heat engine which discharges waste heat into the environment, and it can be called a second type of heat engine. The heat engine has no deflagration phenomenon, low noise, little vibration and no emission. It is quite environment-friendly.

2. Positive Feedback Heat Pump System:

Normal heat pump absorbs heat from a medium with a single temperature, while the positive feedback heat pump system repeatedly absorbs heat from mediums with multiple temperatures and heats up, which means that it absorbs heat from multiple energy storage mediums and hot water with the highest temperature, finally reaching the temperature of hot water with the highest temperature, and then compresses and discharges heat into the hot water and energy storage medium with the highest temperature in succession, and gradually raises the temperature of hot water with the highest temperature and the energy storage medium. In this way, the difference between the temperature of the refrigerant in the heat pump before compression and after compression is always very small. That is to say that the heat pump has been working in a state with a small temperature difference. When calculated according to the ideal reverse Carnot cycle efficiency T1/(T2−T1), as long as the temperature difference is small enough, the energy efficiency of heat pump will be pretty high, and it won't start compression and heating when the temperature of the refrigerant is low, or start evaporative refrigeration when the refrigerant is hot, so during the whole process the efficiency of heat pump is very high and much higher than that of normal heat pumps. In the same way, for the cold end, after heat release the refrigerant in the heat pump is cooled to the ambient temperature by the storage medium, and then continues to cool to the temperature of water with the lowest temperature. The working medium which has reached the lowest temperature is then gasified. Water with the lowest temperature and the energy storage medium are cooled successively in turn. The process is repeated in this way. In the heat pump compressor, before and after decompression the evaporation working medium has a pressure difference, and its volume expands. Energy can be recycled by the working cylinder (such as a steam engine) or turbine motor.

The working process of the positive feedback heat pump system is as follows, as shown in FIG. 1.

Here, water is energy storage medium. The working medium gas with high temperature and high pressure after the compression of a compressor (1) enters through the pipeline, and is liquefied and cooled in Container A (2). It then passes through Container B (3), Container C (4), Container D (5), Container E (6), Container F (7) and Container G (8), gradually cools to the lowest temperature, and then passes through a throttle valve (9), is gasified and absorbs heat in Container G (8) and Container F (7), and enters Tank B (10). The low-temperature working medium then goes through a valve (11), Container E (6), Container D (5), Container C (4), Container B (3) and Container A (2) in succession. After it is gradually heated from the lowest temperature to the highest temperature and changes into high-temperature and high-pressure gas, the working medium pushes the steam engine (12) to apply work, and the gas enters Tank A (13). The working medium is then heated by water in Container A (2) again, and compressed by the compressor (1). The process is repeated in this way. Finally, the temperature of water is the highest in Container A (2), and then reduces in succession. The temperature of water in Container G (8) is the lowest. Because the temperature of water in the containers increases gradually, and the heat pump has been working in a state with a small temperature difference, when calculated according to the ideal reverse Carnot cycle efficiency T1/(T2−T1), as long as the temperature difference is small enough, the energy efficiency of heat pump will be pretty high. The working medium absorbs heat from water in each container, and changes from liquid into high-temperature and high-pressure steam. It has a high working capacity and energy can be recycled. The recycled part of heat pump energy can significantly increase volume and cost. When the device applies work to the outside with the multistage heat exchange technology, its capability to apply work to the outside is high enough. In order to reduce the volume and cost, we can choose not to use it.

This invention can effectively convert heat energy in the environment into mechanical energy(or electric energy), its structure is simple and reliable, and it will make energy ubiquitous and as free as air, change the world greatly.

### DESCRIPTION OF THE DRAWINGS

FIG. 1 is the principle diagram of the positive feedback heat pump.

FIG. 2 is the principle diagram of the first embodiment of the invention.

FIG. 3 is the principle diagram of the second embodiment of the invention.

FIG. 4 is the principle diagram of the third embodiment of the invention.

### MARKERS OF THE DRAWINGS

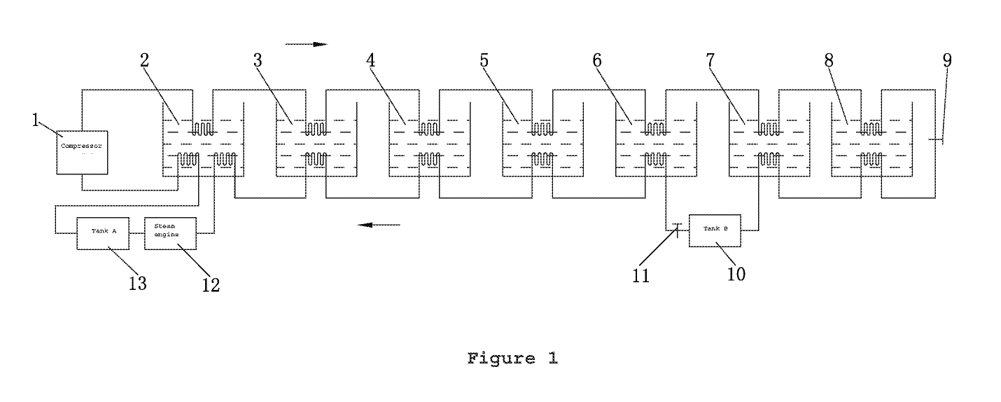

In FIG. 1:

1—Compressor 2—Container A 3—Container B 4—Container C 5—Container D 6—Container E 7—Container F 8—Container G 9—Throttle valve 10—Tank B 11—Valve 12—Steam engine 13—Tank A

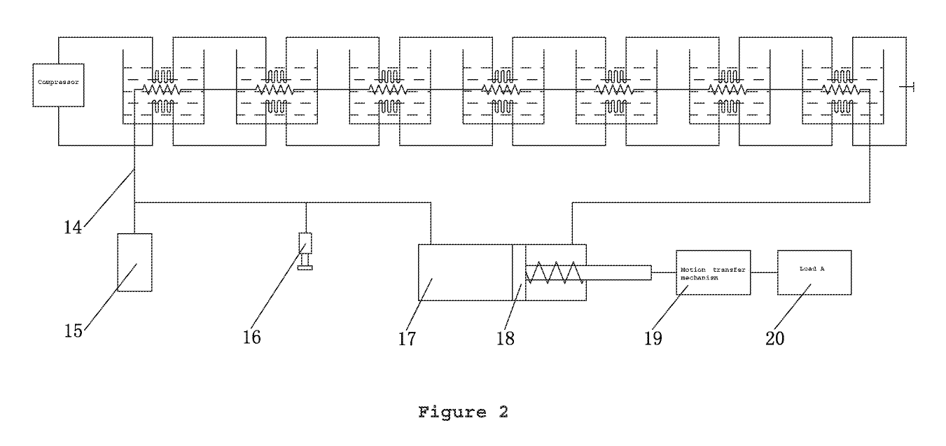

In FIG. 2:

14—Pipeline 15—Starter 16—Pressure limiting Valve 17—Hydraulic cylinder 18—Piston 19—Motion transfer mechanism 20—Load A

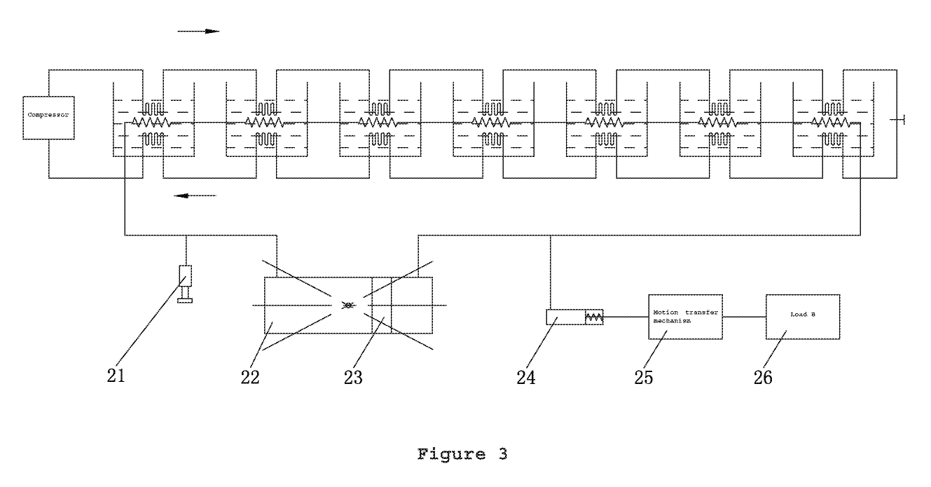

In FIG. 3:

21—Pressure limiting valve 22—Liquid moving Cylinder 23—Heavy piston 24—Hydraulic cylinder 25—Motion transfer mechanism 26—Load B

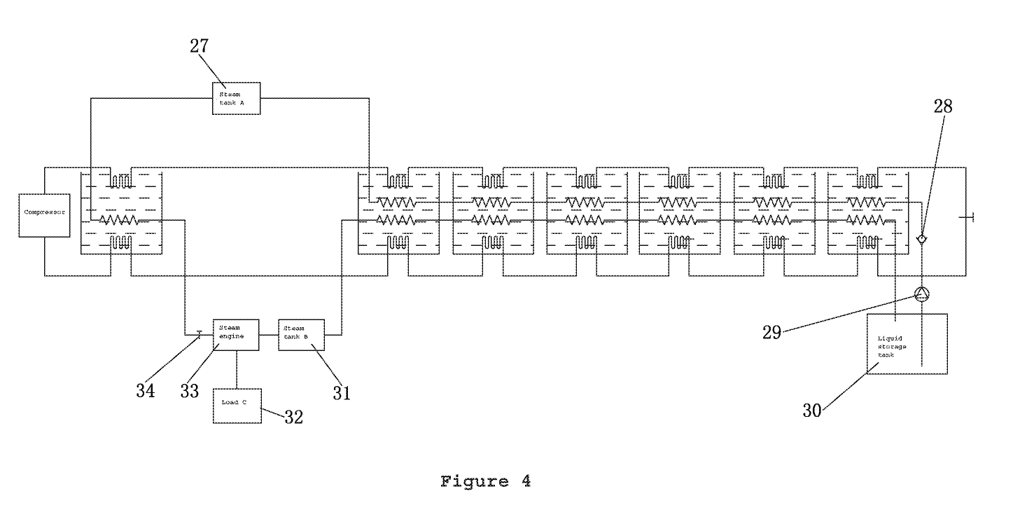

In FIG. 4:

27—Steam tank A 28—One-Way valve 29—Medium pump 30—Liquid storage tank 31—Steam tank B 32—Load C 33—Steam engine 34—Valve

### DETAILED DESCRIPTION OF EMBODIMENTS

With reference to the attached picture, the embodiments s of the present invention are now described. Similar part designators in the attached picture represent similar components.

### Embodiment 1

See FIG. 2. Its working process is as follows:

In the heat pump part, the Embodiment omits the energy recovery part, its working principle is shown in the part of the positive feedback heat pump.

Take some liquid with high expansion as the working medium, the pipeline (14), a Hydraulic cylinder(17), a Starter (15) and other accessories are interconnected. When the starter is heated (the starter can be placed in the container with the highest temperature, hot water can be added into the container with the highest temperature at the beginning), the working medium expands, so that the intensity of pressure inside the entire connector increases. Here, the Hydraulic cylinder (17) is connected into a differential mode, at first the Piston (18) moves to the right, at the same time, the Piston (18) moves the working medium to the right of the Piston (18) and in the pipeline passes through a multistage heat exchange device towards the left of the piston, the temperature of water in the leftmost multistage heat exchange container is the highest, the temperature of water in other containers reduces successively, the temperature of water in the rightmost container is the lowest. The working medium is heated during the process of moving. When the ratio of the diameter of Piston (18) and the diameter of piston rod is large enough, the volume increase of the moved working medium when it is heated is greater than or equal to the volume reduction caused by movement of the piston rod, the Piston (18) will keep moving, and the piston rod applies work to the outside through the Motion transfer mechanism (19), at the same time the return spring is compressed, the Motion transfer mechanism (19) drives the flywheel to rotate and applies work on Load A (20). Load A (20) can be an energy storage device or other loads. When the Piston (18) moves to the rightmost end, a crankshaft and a return spring push the Piston (18) to move in a reverse direction. At this time, the intensity of the pressure of working medium will rise to the highest level, the pressure limiting valve (16) is opened, and part of the working medium enters the Pressure limiting valve (16), so as to prevent excessive pressure of the working medium. When the Piston (18) moves in a reverse direction and the amount of the cooled working medium reaches a certain amount, the intensity of pressure in the system begins to decrease, and the working medium in the Pressure-limiting valve (16) is pressed back into the pipeline. As the Piston (18) continues to move, the intensity of pressure in the system further reduces and is lower than the atmospheric pressure, at the same time, under the action of the return spring, the Piston (18) moves to the left. When the Piston (18) moves liquid to the far left, under the action of inertia of the flywheel, the piston changes the direction again and moves toward the right. The process is repeated in this way. When the temperature of water in the multistage heat exchange container reduces to a certain level, a part of work applied by the device to the outside is used to start the heat pump compressor, and it stops after reaching a certain temperature.

We now take the liquid working medium with a high expansion coefficient as an example to describe the fundamental model. obviously it also can use some kind of gas as working medium.

### Embodiment 2

The working process of the heat pump part is the same as embodiment 1.

In the drawing, the left end of the multistage heat exchange container has the highest temperature, and the right end has the lowest temperature. The working process is as follow, when the Liquid moving cylinder (22) rotates to a certain angle clockwise, under the action of gravity a Heavy piston (23) moves downward, at the same time, it presses the liquid working medium, and the liquid working medium passes through the multistage heat exchange device, and moves to the left of Liquid moving cylinder (22), when passing through the multistage heat exchange device, the working medium gradually heats up and expands, which results in increase of the volume in the whole connecting vessels, the piston of the Hydraulic cylinder (24) is pushed to apply work to the outside through the Motion transfer mechanism (25), compress the return spring at the same time, and drives the flywheel to rotate, applies work on Load B (26). When the Heavy piston (23) in the liquid moving cylinder declines to the lowest position, the Liquid moving cylinder (22) rotates to a certain angle anticlockwise, the position of Heavy piston (23) rises from the lowest position to the highest position, under the action of gravity, through the heat exchange device the liquid working medium is then moved in the reverse direction again, so that the working medium gradually cools and the volume reduces, and the return spring drives the piston of the Hydraulic cylinder (24) to apply work. When the Heavy piston (23) reaches the lowest position again, the Liquid moving cylinder (22) rotates to a certain angle in the reverse direction, so that the Heavy piston(23) drops and moves the liquid again. The process is repeated in this way. When the liquid expands, the intensity of pressure can be very high, and a Pressure limiting valve (21) is required to prevent excessive pressure in the whole connector, which may cause damage. When the temperature of water in the multistage heat exchange container falls to a certain level, part of the work applied by the device to the outside is used to start the heat pump compressor, and it will stop after reaching a certain temperature.

This method actually separates the piston and piston rod in Method 1. The swing type is suitable for the model of double cylinder system. it needs a large space, and is suitable for fixed occasions. The liquid moving cylinder can also be fixed, and the piston is moved by external force. For example, a magnet can be used. At this time, the piston can be a lightweight piston equipped with a magnet or an iron piston can be directly used. The cylinder needs to be made of non-ferromagnetic material, such as austenitic stainless steel. The heavy piston in the cylinder body can also be a light piston. By adding an oil pump in the pipeline, the liquid can be moved to and fro, which can make the structure more compact and not easily affected by position. With this method, the working medium also can be gas. Only the basic model is described here. On this basis, double cylinders, multiple cylinders and other technical proposals still fall under the scope for which protection is applied.

### Embodiment 3

The working process of the heat pump part is the same as embodiment 1.

This method applies work with low-temperature steam, it is relatively suitable for power plants. In the drawing the temperature of water in the multistage heat exchange container is the highest on the left and lowest on the right. The working medium with a low boiling point is placed in a Liquid storage tank (30). At the start, the working Medium pump (29) is started and delivers the liquid working medium through a One-way valve (28) and a multistage heat exchange container to Steam Tank A (27). During the process, the working medium is gradually heated and gasified, and after it is heated in the container with the highest temperature the gaseous working medium it then goes through a Valve (34) and drives the Steam engine (33) (or turbine motor, etc.) to apply work on Load C (32). After working, the steam goes into Steam Tank B(31), and then passes through the containers for multistage cooling and liquidation, enters the Liquid storage tank (30), and is then delivered by a Medium pump (29) in a reverse direction to Steam tank A (27). The process is repeated in this way. When the temperature of water in the container falls to a certain level, part of the work applied by the device to the outside is used to start the heat pump compressor, and it will stop after reaching a certain temperature.

Described above are only preferred embodiments for the present invention. Of course, we cannot limit the scope of rights of the present invention with them. Therefore, the equivalent changes made in accordance with the scope of the patent applied for the invention are still within the scope covered by the present invention.

What is claimed is:

1. A device which applies work to the outside with environmental thermal energy, comprising a positive feedback heat pump system and a reciprocating multistage heat exchange working system. The positive feedback heat pump creates a high temperature heat source and a low temperature heat source. The reciprocating multistage heat-exchange working device applies work with heat energy and cold energy. First, the fluid working medium is moved in the forward direction and passes multiple containers with energy storage media, so that the fluid working medium gradually cools down or heats up to the required temperature. At the same time, energy storage mediums with different qualities are obtained. Subsequently, fluid working mediums are moved in a reverse direction in turn, and pass multiple containers with energy storage mediums, so that the link gradually heats or cools to the required temperature to use heat energy or cold energy stored in the storage medium once again, and to make full use of heat energy or cold energy.

2. The device which applies work to the outside with environment thermal energy mentioned in claim 1 comprises a positive feedback heat pump system.

3. The device which applies work to the outside with environment thermal energy mentioned in claim 1 comprises a reciprocating multistage heat exchange working system.

4. The positive feedback heat pump system according to claim 2 comprises a heat pump, several container with medium in it, and pipelines which go through the containers.

5. A device which applies work to the outside with environmental thermal energy according to claim 1 comprises a positive feedback heat pump system and a reciprocating multistage heat exchange working system, wherein the reciprocating multistage heat exchange working system comprises a hydraulic cylinder in differential output form, and a pressure limiting valve.

6. A device which applies work to the outside with environmental thermal energy according to claim 1 comprises a positive feedback heat pump system and a reciprocating multistage heat exchange working system, wherein the reciprocating multistage heat exchange working system comprises a fluid moving cylinder with a piston in it, and a cylinder to apply work.

7. A device which applies work to the outside with environmental thermal energy according to claim 1 comprise a positive feedback heat pump system and a reciprocating multistage heat exchange working system, wherein the reciprocating multistage heat exchange working system comprises a steam engine and a medium pump.
